(19) United States
(12) Patent Application Publication
(10) Pub. No.: US 2024/0102179 A1
(43) Pub. Date: Mar. 28, 2024

(54) PROCESS FOR PRODUCING LOW, NEUTRAL, AND/OR NEGATIVE CARBON INTENSITY HYDROGEN THROUGH ELECTROLYSIS

(71) Applicant: Kraken Technology Holdings, LLC, Houston, TX (US)

(72) Inventors: Christopher Michael MILLER, Richmond, TX (US); Anna Louise BUCKLEY, Houston, TX (US); Byron Gladus BEST, III, Katy, TX (US); Bengt Arne JARLSJO, Houston, TX (US); Daniel Joseph SHAPIRO, Houston, TX (US)

(21) Appl. No.: 18/471,768

(22) Filed: Sep. 21, 2023

Related U.S. Application Data
(63) Continuation-in-part of application No. 18/117,606, filed on Mar. 6, 2023.
(60) Provisional application No. 63/451,940, filed on Mar. 14, 2023.
(60) Provisional application No. 63/409,331, filed on Sep. 23, 2022.

(51) Int. Cl. C25B 1/04

(52) U.S. Cl. CPC C25B 1/04

(57) ABSTRACT

Methods for producing a hydrogen product having a carbon intensity less than about 0.45 kg CO₂e/kg H₂ is provided. The method includes the steps of converting water to oxygen and the hydrogen product through an electrolysis process, providing at least some, and substantially all, of the required energy for the electrolysis process from a biomass power plant, and processing one or more flue gas streams from the biomass power plant in a carbon capture unit to reduce CO₂e emissions. The energy produced from the biomass power plant may comprise one or more of electricity, steam used as process steam in the electrolysis process, steam used as thermal energy in the electrolysis process, and steam used to power a mechanical drive for one or more compressors, pumps, or other motors generating shaft torque in the electrolysis process.

### CROSS-REFERENCE TO RELATED APPLICATION

This application claims the benefit of U.S. Prov. App. Nos. 63/451,940 (filed Mar. 14, 2023) and 63/409,331 (filed Sep. 23, 2022), and is a continuation-in-part of U.S. patent application Ser. No. 18/117,606 (filed Mar. 6, 2023), each of which is incorporated by reference herein in its entirety.

### BACKGROUND

The present invention relates to a method for producing hydrogen product having reduced carbon intensity. More specifically, the method includes the production of hydrogen by electrolysis of water, where the energy for electrolysis is provided by the combustion or gasification of various forms of biomass to reduce the carbon intensity of the hydrogen product. The present invention also includes a method for producing one or more reduced carbon intensity hydrogen derivatives, such as ammonia, where the energy to produce the hydrogen derivative is generated from the combustion or gasification of various forms of biomass. In all embodiments of the present invention, the biogenic carbon dioxide produced from the combustion or gasification of biomass is preferably separated and removed in a carbon capture unit.

Hydrogen is widely considered a strong alternative as a decarbonized energy carrier and storage medium to reduce the carbon footprint of many industries, transportation, services, etc. As of 2022, over 90% of the world's hydrogen production is made by reforming hydrocarbons (most typically natural gas) without carbon capture.

In order to achieve a net reduction of carbon emissions, hydrogen must be produced with low carbon technology and/or low carbon feedstocks. Currently available options for producing reduced carbon intensity hydrogen include: (1) hydrocarbon reforming with carbon capture where the captured carbon dioxide may be permanently sequestered in a geologic repository or stored in a for-use application; (2) reforming of low carbon intensity hydrocarbon feeds, including biogas, renewable natural gas, and/or certified, low-methane leakage natural gas; (3) electrolysis of water using low carbon power (typically solar, wind, hydro, or nuclear power); (4) catalytic splitting of water using nuclear power; and (5) splitting of methane via methane pyrolysis.

Hydrogen carbon intensity may be evaluated using a life cycle analysis methodology such as Argonne National Laboratory's Greenhouse Gases, Regulated Emissions, and Energy Use in Technologies Model (GREET). The term “carbon intensity” refers to a measure of the amount of equivalent carbon dioxide (CO₂e) emitted to produce a specified amount of a product, such as hydrogen or ammonia. CO₂e is a common unit used to sum various greenhouse gases based on their global warming potential (GWP). Hydrogen carbon intensity is frequently rated in kilograms of equivalent carbon dioxide per kilogram of hydrogen (kg CO₂e/kg H₂). Ammonia carbon intensity is similarly measured in kg CO₂e/kg NH₃.

Hydrogen produced by reforming of natural gas without carbon capture will normally result in a carbon intensity exceeding 10 kg CO₂e/kg H₂. With carbon capture technology and renewable energy, the lowest practically achievable carbon intensity hydrogen produced by reforming responsibly sourced natural gas is significantly greater than 1.0 kg CO₂e/kg H₂.

Electrolysis can produce a lower carbon intensity hydrogen as compared to hydrogen derived from reforming fossil fuels if the power consumed is sufficiently low carbon intensity. Hydrogen produced by electrolysis will result in a carbon intensity exceeding 25 kg CO₂e/kg H₂ when using an average U.S. grid electricity mix of 465 kg CO₂e/MWh to provide power to the electrolysis unit. Hydrogen produced by electrolysis using solar, wind, hydro, or other forms of renewable power that is directly connected to the electrolysis unit will result in a theoretical carbon intensity of about 0.0 kg CO₂e/kg H₂ (excluding emissions related to production, maintenance, and/or decommissioning of infrastructure required for renewable power generation).

As such, it is well understood that hydrogen produced via electrolysis with renewable energy may have a lower carbon intensity than hydrogen produced through the reforming of hydrocarbons; however, the usage of renewable power presents additional challenges. Solar, wind, and hydro power are challenged by location, variable load generation, and cost.

Electrolysis requires a constant supply of power. Solar and wind power, for instance, have low-capacity factors and can only generate power under certain conditions. As renewable energy production decreases based on regional capacity factors, so will hydrogen. For renewable energy to provide a constant supply of power for electrolysis, energy storage solutions must be considered to maintain a steady hydrogen production rate. Energy storage solutions (e.g., batteries) can be very costly, difficult to scale, and consume vast quantities of scarce metals. Hydropower can also be subject to fluctuations due to changes in weather patterns that lead to droughts or flooding. The large-scale production of renewable power required for the production of carbon neutral hydrogen from electrolysis will be limited based on the geographical constraints and regional capacity factors of solar, wind, and hydro power.

To account for the variability from solar, wind, and/or hydro power generation without energy storage solutions, electrolysis units may elect to balance the non-dispatchable, lower carbon intensity renewable power with dispatchable, higher carbon intensity power. Hydrogen produced from electrolysis with on-shore wind power, assuming a capacity factor of 55%, and balanced with an average U.S. grid electricity mix of 465 kg CO₂e/MWh, would result in a carbon intensity of about 11.6 kg CO₂e/kg H₂.

With the passing of the Inflation Reduction Act (IRA) in 2022, the United States now provides a tax credit based on the lifecycle carbon emissions associated with the production of clean hydrogen, including a large tax credit for producing hydrogen with a carbon intensity less than about 0.45 kg CO₂e/kg H₂. Producing hydrogen in accordance with the present invention preferably results in a product carbon intensity less than about 0.45 kg CO₂e/kg H₂, and more preferably less than about 0.0 kg CO₂e/kg H₂.

### SUMMARY OF THE INVENTION

Methods for producing a hydrogen product having a carbon intensity less than about 0.45 kg CO₂e/kg H₂ is provided. The methods include the steps of converting water to oxygen and the hydrogen product through an electrolysis process, providing at least some, and substantially all, of the required energy for the electrolysis process from a biomass power plant, and processing one or more flue gas streams from the biomass power plant in a carbon capture unit to reduce CO₂e emissions. The hydrogen product has a carbon intensity preferably less than about 0.45 kg CO₂e/kg H₂, and more preferably less than about 0.0 kg CO₂e/kg H₂.

At least some of the required energy for the electrolysis process may be provided from a higher carbon intensity energy source. At least some of the required energy for the carbon capture unit from the biomass power plant. The energy produced from the biomass power plant may comprise one or more of electricity, steam used as process steam in the electrolysis process, steam used as thermal energy in the electrolysis process, and steam used to power a mechanical drive for one or more compressors, pumps, or other motors generating shaft torque in the electrolysis process. The energy produced from the biomass power plant may be generated by a Rankine cycle, a Brayton cycle, or by the gasification of biomass in an integrated gasification combined cycle. The biomass feedstock for the biomass power plant comprises one or more renewably sourced fuels selected from woody biomass, municipal solid waste, sorted municipal solid waste, food waste, agricultural waste, landfill diversion, hurricane and construction debris, industrial processing biomass waste, renewable natural gas, or a combination thereof, and may be co-fired with one or more fossil fuels.

The electrolysis process is selected from polymer electrolyte membrane electrolysis, alkaline electrolysis, solid oxide electrolysis, or a combination thereof. The carbon capture unit comprises pressurizing the carbon dioxide product therefrom, wherein at least some of the required energy for the carbon dioxide pressurization is provided from the biomass power plant. The electrolysis process comprises compressing the hydrogen product, wherein at least some of the required energy for the hydrogen compressor is provided from the biomass power plant. The hydrogen production process comprises hydrogen liquefaction, wherein at least some of the required energy for the hydrogen liquefaction is provided from the biomass power plant. The biomass power plant comprises oxy-combustion of the biomass feedstock, wherein at least some of the required oxygen required for the oxy-combustion is provided by the electrolysis process.

### DESCRIPTION OF FIGURES

The features and advantages of the present invention will be more clearly understood from the following description taken in conjunction with the accompanying drawings in which:

FIG. 1 depicts a process flow diagram for producing low, neutral, and/or negative carbon intensity hydrogen from electrolysis, wherein the required energy is produced from a biomass power plant with carbon capture.

FIG. 2 depicts a process flow diagram producing low, neutral, and/or negative carbon intensity hydrogen from electrolysis, wherein the required energy is produced from a biomass power plant with carbon capture and a gas turbine with carbon capture.

FIG. 3 depicts a process flow diagram producing low, neutral, and/or negative carbon intensity ammonia from electrolysis, wherein the required energy is produced in a biomass power plant with carbon capture.

FIG. 4 depicts a process flow diagram for the process of FIG. 1, in which the biomass power plant is illustrated as a traditional, air fired biomass boiler with carbon capture.

FIG. 5 depicts a process flow diagram for the process of FIG. 1, in which the biomass power plant is illustrated as an oxy-fired biomass boiler with carbon capture.

FIG. 6 depicts a process flow diagram for the process of FIG. 2, wherein the required energy is provided by a biomass boiler with carbon capture and a combined cycle gas turbine with carbon capture.

### DETAILED DESCRIPTION OF THE INVENTION

The present invention relates to a method for producing hydrogen through electrolysis in which some of the energy for the electrolysis process is provided by the combustion or gasification of various forms of biomass to reduce the carbon intensity of the hydrogen product to less than about 0.45 kg CO₂e/kg H₂, and more preferably less than about 0.0 kg CO₂e/kg H₂. In all embodiments described herein, the biogenic carbon dioxide produced from the combustion or gasification of biomass is separated and removed in a carbon capture unit.

In all embodiments described herein, the electricity generated by the biomass power plant can equal, but does not have to equal, the total amount of electricity required for producing hydrogen through electrolysis.

Furthermore, in all embodiments described herein, the biomass feed to the biomass power plant can be a variety of fuel mixes including but not limited to: woody biomas s, municipal solid waste (MSW), sorted MSW, food waste, agriculture waste, landfill diversion, hurricane and construction debris, industrial processing biomass waste, and renewable natural gas. A person having ordinary skill in the art will appreciate that fossil fuels, including but not limited to natural gas and/or fuel gas (i.e. propane and butanes), can also be co-fired with the biomass as required or desired.

Furthermore, in all embodiments described herein, the biomass power plant is selected from a Rankine cycle, or a Brayton cycle, or an integrated gasification combined cycle (IGCC) consisting of both a Rankine cycle and Brayton cycle.

Where the biomass power plant configuration comprises a Rankine cycle, a biomass boiler produces heat from the direct combustion of biomass to generate steam for the Rankine cycle. In this configuration, the biomass boiler can either be a traditional air fired boiler or oxy-fired boiler using oxygen generated by the electrolysis unit or otherwise supplied by a third-party. Furthermore, where the biomass power plant configuration comprises a Brayton cycle, the gasification of biomass produces a syngas product, with or without steam generation, that is purified before being combusted in the Brayton cycle. The exhaust heat from the Brayton cycle can be used to generate steam for a Rankine cycle.

In all embodiments of the present invention described herein, carbon negative energy from the biomass power plant can be provided as: (1) electrical power, (2) process steam, (3) thermal energy in the form of steam, and/or (4) steam drive energy to power mechanical drives.

Furthermore, in all embodiments described herein, the carbon negative energy produced from the biomass power plant can be combined with higher carbon intensity energy (i.e., local grid electricity and/or electricity produced from a gas turbine) to thereby achieve a targeted hydrogen carbon intensity.

In all embodiments described herein, at least some of the required energy for the production of hydrogen through electrolysis may be provided by a gas turbine. In this configuration, the gas turbine exhaust can be routed to a carbon capture unit to separate and remove the carbon dioxide produced from the combustion of a hydrocarbon fuel.

In all embodiments described herein, the low, neutral, and/or negative carbon intensity hydrogen 105 can be utilized to produce low, neutral, and/or negative carbon intensity hydrogen derivatives and/or hydrogen carriers, including but not limited to ammonia.

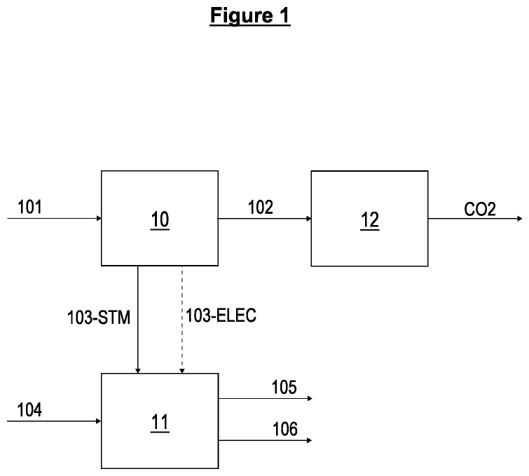

With reference to FIG. 1, a first embodiment of the present invention is depicted, in which the low, neutral, and/or negative carbon intensity hydrogen is produced from electrolysis, wherein the required energy is provided by a biomass power plant with carbon capture.

Biomass power plant 10 generates carbon negative energy in the form of electricity 103-ELEC and/or steam 103-STM. The energy produced from biomass power plant 10 is generated by either a Rankine cycle, a Brayton cycle, or an integrated gasification combined cycle (IGCC) which consists of both a Rankine cycle and Brayton cycle.

Where biomass power plant 10 comprises a Rankine cycle, energy is produced from the direct combustion of biomass feedstock 101 in a biomass boiler to generate steam. The generated steam from the biomass power plant can be sent to a Rankine cycle steam turbine to produce electricity 103-ELEC to provide power to electrolysis unit 11. Furthermore, steam 103-STM can be sent directly to electrolysis unit 11 as process steam for high-temperature steam electrolysis (HTSE) or can be extracted from the turbine and sent as thermal energy to electrolysis unit 11. The use of steam 103-STM in electrolysis unit 11 decreases the amount of electricity required for the electrolysis process.

Where biomass power plant 10 comprises a Brayton cycle, biomass feedstock 101 is gasified to create a syngas product that is combusted as a fuel in a Brayton cycle gas turbine to produce electricity 103-ELEC.

Alternatively, biomass power plant 10 can be configured as an IGCC plant in which the biomass feedstock 101 is gasified to create a syngas product with or without steam generation. The syngas can be combusted as fuel in a Brayton cycle gas turbine to generate electricity 103-ELEC to provide power to electrolysis unit 11. Steam 103-STM can also be generated with a heat recovery steam generator (HRSG) on the gas turbine exhaust. This steam can be used in a Rankine cycle to generate additional electricity 103-ELEC. Steam 103-STM can also be used as process steam for HTSE or as thermal energy in electrolysis unit 11. Additional uses of this carbon negative energy (103-ELEC and 103-STM) are discussed herein with respect to additional embodiments of the present invention.

In electrolysis unit 11, water 104 is converted to a low, neutral, and/or negative carbon intensity hydrogen 105 and oxygen 106 through electrolysis using carbon negative energy in the form of electricity, 103-ELEC, and/or steam, 103-STM, from biomass power plant 10. As discussed above, the carbon negative energy produced from biomass power plant 10 can be combined with higher carbon intensity energy (not shown), including grid import power, to achieve a targeted carbon intensity of hydrogen 105.

Carbon dioxide 102 can be captured from the biomass power plant flue gas stream. Carbon dioxide 102 can be compressed in CO₂ compression unit 12 and sent to geologic sequestration or can otherwise be used external to the process.

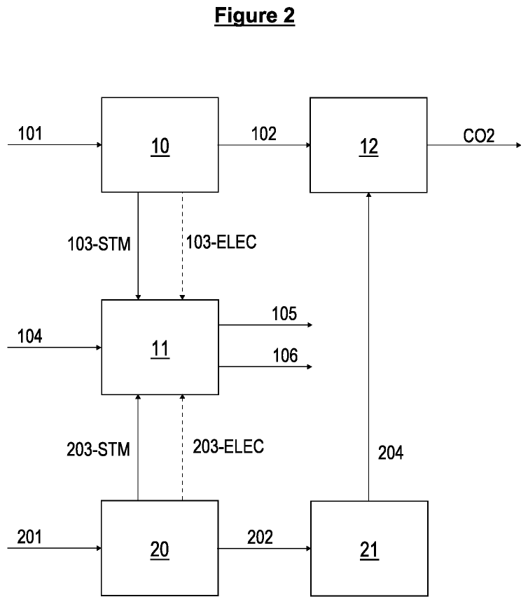

In a second embodiment of the present invention, FIG. 2 illustrates the production of low, neutral, and/or negative carbon intensity hydrogen from electrolysis, wherein the required energy is provided by a biomass power plant with carbon capture and a gas turbine with carbon capture.

Similar to FIG. 1, water 104 is converted to a low, neutral, and/or negative carbon intensity hydrogen 105 and oxygen 106 in electrolysis unit 11 with carbon negative energy in the form of electricity, 103-ELEC, and/or steam, 103-STM, from biomass power plant 10.

Hydrocarbon fuel 201 is combusted in gas turbine 20, utilizing a Brayton cycle to generate low or neutral carbon intensity electricity 203-ELEC to provide power to electrolysis unit 11. Steam 203-STM can also be generated with a HRSG on the gas turbine exhaust. This steam can be used in a Rankine cycle to generate additional electricity 203-ELEC. Steam 203-STM can also be used as process steam for HTSE or as thermal energy in electrolysis unit 11.

Although not shown in FIG. 2, hydrocarbon fuel 201 can be blended with hydrogen 105 or can be wholly comprised of hydrogen 105 to reduce CO₂e emissions associated with energy, in the form of electricity, 203-ELEC, and/or steam, 203-STM, produced in gas turbine 20.

Carbon dioxide 204 can be separated and removed from turbine exhaust 202 in post-combustion capture (PCC) unit 21. Carbon dioxide 204 along with carbon dioxide 102 from biomass power plant 10 can be compressed in CO₂ compression unit 12 and sent to geologic sequestration or can otherwise be used external to the process. Gas turbine 20 can be configured as simple cycle, combined cycle, cogeneration, or a combination thereof.

The low or neutral carbon intensity power from gas turbine 20 can be combined with the carbon negative energy produced from the biomass power plant to achieve a targeted hydrogen carbon intensity. More specifically, where the power produced by gas turbine 20 has a lower carbon intensity than grid import power, the amount of required negative carbon intensity from the biomass power plant to achieve a targeted hydrogen carbon intensity is reduced.

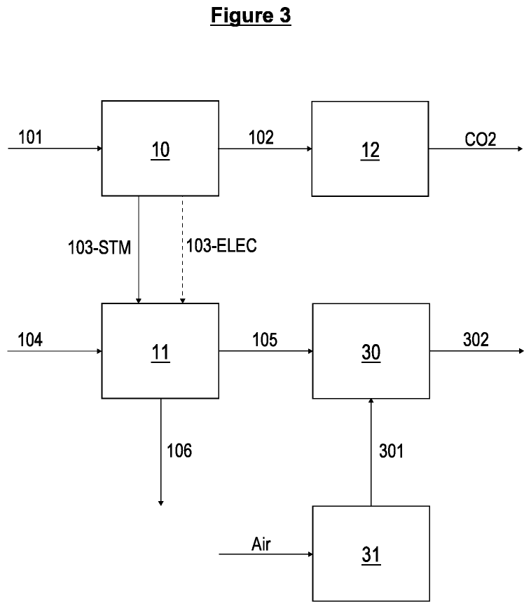

In a third embodiment of the present invention, FIG. 3 illustrates the production of hydrogen from electrolysis with energy provided from a biomass power plant with carbon capture to produce low, neutral, and/or negative carbon intensity hydrogen that is then converted to low carbon intensity ammonia.

Similar to FIG. 1 and FIG. 2, water 104 is converted to a low, neutral, and/or negative carbon intensity hydrogen 105 and oxygen 106 in electrolysis unit 11.

Hydrogen 105 from electrolysis unit 11 and nitrogen 301 are converted to a low, neutral, and/or negative carbon intensity ammonia 302 in ammonia synthesis unit 30. Nitrogen 301 used for ammonia synthesis can be generated by air separation unit (ASU) 31 and/or be provided by a third-party supplier.

Although not shown, biomass power plant 10 can also provide carbon negative energy in the form of electricity, 103-ELEC, and/or steam, 103-STM, to ammonia synthesis 30 and/or ASU 31.

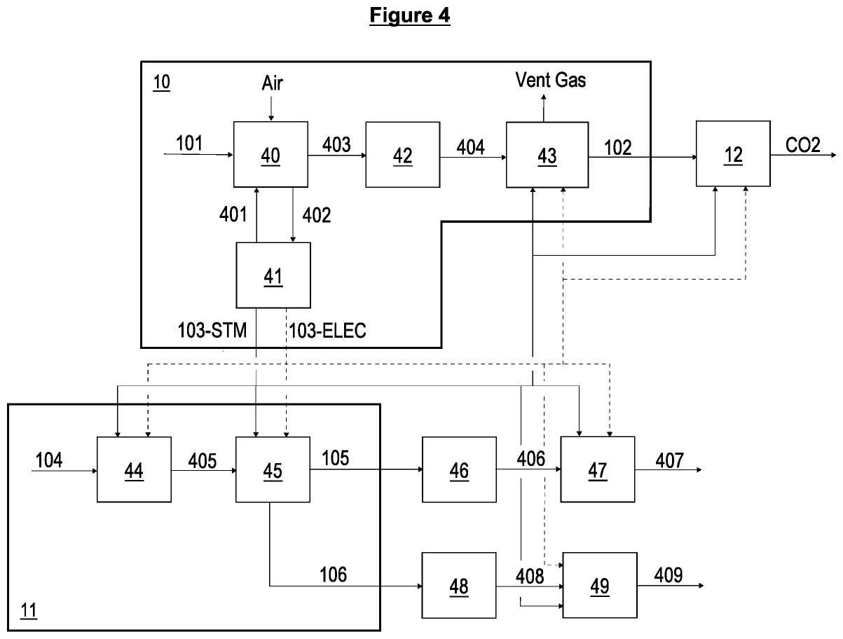

In a fourth embodiment of the present invention, FIG. 4 depicts the production of low, neutral, and/or negative carbon intensity hydrogen from electrolysis, wherein the required energy is provided by biomass power plant 10, more specifically a Rankine cycle power plant, with carbon capture.

Raw water 104 is sent to water treatment unit 44 to remove impurities, such as particulates, organic compounds, and/or mineral salts to produce treated or deionized water 405. Depending on the quality of the raw water, different technologies may be required to achieve the desired treated water quality, as would be understood by a person having ordinary skill in the art. Treated or deionized water 405 is sent to electrolyzer 45. Biomass power plant can provide electrical energy 103-ELEC to power equipment motors, including but not limited to the feed water pumps, auxiliary equipment, instrumentation, and controls. Steam 103-STM from biomass power plant 10 can be supplied as thermal energy for process heating requirements, and/or steam drive energy to power the mechanical drive (e.g., turbines) for rotating equipment (e.g., pumps, compressors).

Electrolyzer 45 consists of multiple electrolytic stacks that contain a cathode and an anode that are separated by a membrane. Electrolysis occurs when an electric current is applied across the electrolyte, thereby splitting water into hydrogen and oxygen.

Where electrolyzer 45 is comprised of polymer electrolyte membrane (PEM), water reacts with the anode of the electrolytic cell stack to form oxygen and positively charged hydrogen ions. The positively charged hydrogen ions pass through the electrolyte membrane and combine at the cathode to form hydrogen.

Where electrolyzer 45 is comprised of a solid oxide electrolyzer, steam at elevated temperatures reacts with the cathode to form hydrogen and negatively charged oxygen ions. The negatively charged oxygen ions pass through the solid membrane and combine at the anode to form oxygen.

Electrolyzer 45 can receive carbon negative energy in four forms: (1) electrical power 103-ELEC that can be used to provide power to the electrolytic cells, rotating equipment motors, including but not limited to the water circulation pumps, auxiliary equipment, instrumentation, and controls; (2) process steam for high-temperature steam electrolysis, including but not limited to the use of solid oxide electrolytic cells (SOEC); (3) thermal energy in the form of steam 103-STM for process heating requirements, including but not limited to the water circulation heater; and/or (4) steam drive energy to power the mechanical drive of rotating equipment.

Hydrogen produced in electrolyzer 45 is sent to a water separator (not shown) to remove water. Depending on the desired moisture content, the hydrogen can also be sent to a dryer system. Temperature swing adsorption (TSA) systems are commonly used to achieve the desired moisture content of the hydrogen product 105, but other alternative technologies known in the art can also be utilized.

Hydrogen 105 is sent to hydrogen storage 46, and stored hydrogen 406 can be compressed in hydrogen compression unit 47. Hydrogen compression unit 47 can use electrical energy 103-ELEC from biomass power plant 10 to power the hydrogen compressor motor, auxiliary equipment, instrumentation, and controls. Alternatively, steam 103-STM from biomass power plant 10 can be supplied directly to power the mechanical drive for the hydrogen compressor.

Oxygen produced in electrolyzer 45 is sent to a water separator (not shown) to remove water. Oxygen 106 is sent to oxygen storage 48, and stored oxygen 408 can be compressed in oxygen compression unit 49. Oxygen compression unit 49 can use electrical energy 103-ELEC from biomass power plant 10 to power the oxygen compressor motor, auxiliary equipment, instrumentation, and controls. Alternatively, steam 103-STM from biomass power plant 10 can be supplied directly to power the mechanical drive for the oxygen compressor.

The energy and/or steam from biomass power plant 10 is generated by combusting biomass feedstock 101 in a traditional, air fired boiler 40. The heat from the combustion of biomass feedstock 101 can be used to produce steam 402 from boiler feed water 401 that can be used to generate electricity in steam turbine 41. Not shown in FIG. 4, steam 402 can also be sent directly to electrolysis unit 11 for use as process steam for HTSE, thermal energy for process heating requirements, and/or steam drive energy to power mechanical drive for rotating equipment.

Flue gas 403 from boiler 40 is sent through air quality control system 42, where it passes through one or more emissions reduction technologies such as a pulse jet fabric filter, dry sorbent injection system, selective catalytic reduction (SCR), and carbon monoxide catalyst. These environmental train technologies are optional to treat flue gas 403 depending on the specific site needs, and would be well understood by a person having ordinary skill in the art.

Also not shown in FIG. 4, electricity 103-ELEC and steam 103-STM from biomass power plant 10 can alternatively be generated by the gasification of the biomass feedstock. The gasification of the biomass in the presence of air, steam, or oxygen results in a syngas product consisting of mostly carbon monoxide and hydrogen. Any impurities produced in the syngas are removed in a syngas clean-up step. The syngas can be combusted in a gas turbine to produce electricity 103-ELEC. Optionally, a HRSG can be included on the turbine exhaust to produce steam. This steam can be used to generate additional electricity in a steam turbine or can be sent directly to the hydrogen plant for use as process steam for HTSE, thermal energy for process heating requirements, and/or steam drive energy to power the mechanical drive for rotating equipment. The exhaust from the HRSG can be sent to a post-combustion carbon capture unit to reduce CO₂e emissions.

Treated flue gas 404 is then sent to PCC unit 43. The PCC technology employed for carbon capture can include a cryogenic process or an amine-based solution. PCC unit 43 can receive carbon negative energy in three forms: (1) electrical power 103-ELEC that can be used to provide power to rotating equipment motors, including but not limited to the amine pumps (amine-based carbon capture), liquid carbon dioxide pumps (cryogenic carbon capture), auxiliary equipment, instrumentation, and controls; (2) thermal energy in the form of steam 103-STM for process heating requirements, including but not limited to the amine regenerator reboiler (amine-based carbon capture); and/or (3) steam drive energy to power the mechanical drive of rotating equipment.

Purified carbon dioxide 102 can be compressed in CO₂ compression unit 12 for geologic sequestration or can otherwise be used external to the process. CO₂ compression unit 12 may use electrical energy 103-ELEC from biomass power plant 10 to power the CO₂ compressor motor, auxiliary equipment, instrumentation, and controls. Alternatively, steam 103-STM from biomass power plant 10 can be supplied directly to power the mechanical drive for the CO₂ compressor.

Although not shown in FIG. 4, energy from biomass power plant 10 can also be used in the balance of plant, offsites, and utility systems. The carbon negative energy can be in three forms: (1) electrical power 103-ELEC that can be used to provide power to rotating equipment motors, including but not limited to boiler feed water pumps, cooling water pumps, cooling tower fans, compressors located in the air separation unit, auxiliary equipment, instrumentation, and controls; (2) thermal energy in the form of steam 103-STM for process heating requirements, including but not limited to the stripping steam for the deaerator or steam tracing; and/or (3) steam drive energy to power the mechanical drive of the rotating equipment.

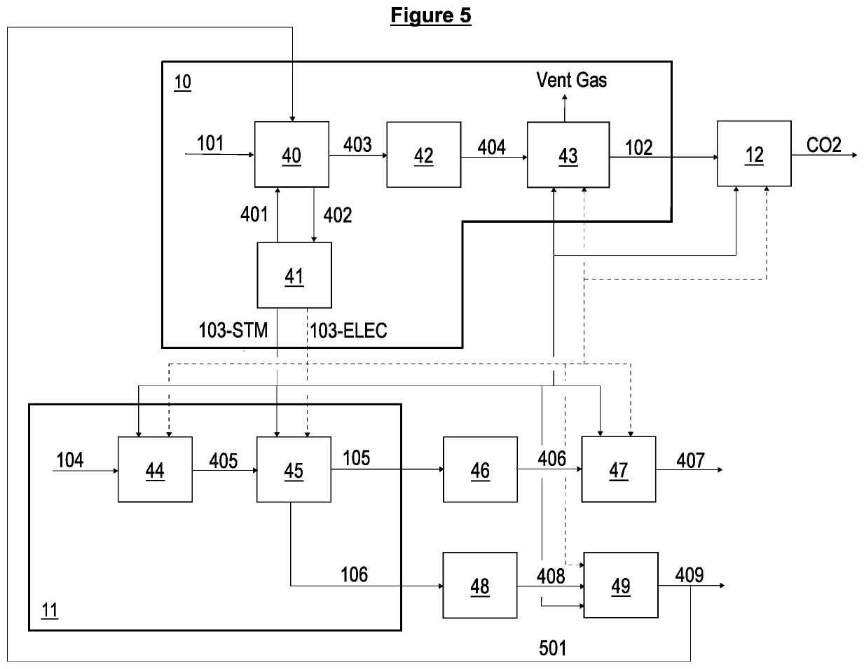

In a fifth embodiment of the present invention, FIG. 5 illustrates a process flow that differs from FIG. 4 in the configuration of biomass power plant 10 with carbon capture. Where the Rankine cycle power plant comprises an oxy-fired boiler, oxygen 501 produced by electrolysis unit 11 can be utilized in boiler 40.

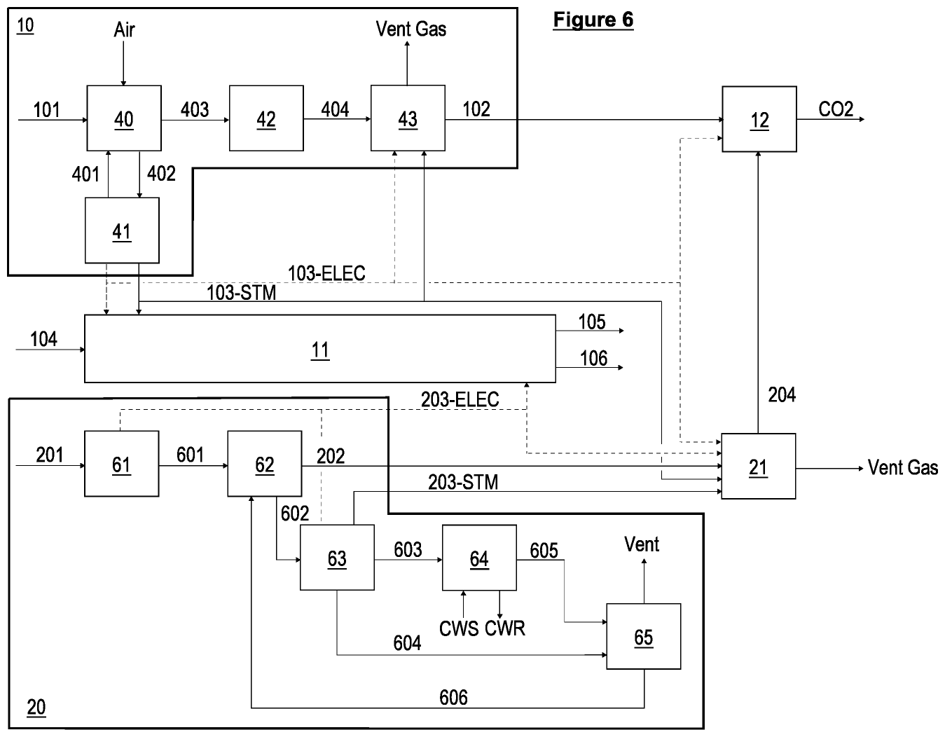

In a sixth embodiment of the present invention, FIG. 6 depicts the production of low, neutral, and/or negative carbon intensity hydrogen from electrolysis, wherein the required energy is provided by biomass power plant 10, more specifically a Rankine cycle power plant, with carbon capture and a gas turbine with carbon capture.

Similar to FIG. 4, raw water 104 is converted to a low, neutral, and/or negative carbon intensity hydrogen 105 and oxygen 106 in electrolysis unit 11 with carbon negative energy in the form of electricity, 103-ELEC, and/or steam, 103-STM, from biomass power plant 10. However, FIG. 6 also depicts a combined cycle gas turbine providing low and/or neutral carbon intensity energy in the form of electricity, 203-ELEC, and/or steam, 203-STM to produce low, neutral, and/or negative carbon intensity hydrogen 105.

Hydrocarbon fuel 201 is sent to gas turbine 61 and is combusted to generate low and/or neutral carbon intensity electricity 203-ELEC in a Brayton cycle to power electrolysis unit 11. Turbine exhaust 601 is sent to HRSG 62, and the cooled turbine exhaust 202 is sent to PCC unit 21.

Superheated steam 602 is produced in HRSG 62 from the waste heat from turbine exhaust 601. Superheated steam 602 is sent to steam turbine 63, in which additional low and/or neutral carbon intensity electricity 203-ELEC is produced by a Rankine cycle to power electrolysis unit 11. Steam turbine exhaust 603 is condensed in surface condenser 64, and condensate 605 is sent to deaerator 65. Deaerator stripping steam 604 is extracted from steam turbine 63. Boiler feed water 606 from deaerator 65 is sent to HRSG 62 to produce superheated steam 602.

Although not shown, HRSG 62 can also be configured to be duct fired to produce additional superheated steam and thus generate additional electricity.

Emissions controls, such as a selective catalytic reduction (SCR) which requires ammonia injection, can also be added to HRSG 62 to treat the turbine exhaust prior to being sent to PCC unit 21.

Carbon dioxide 204 can be separated and removed from turbine exhaust 202 in PCC unit 21. Carbon dioxide 204 along with carbon dioxide 102 from biomass power plant 10 can be compressed in CO₂ compression unit 12 and sent to geologic sequestration or otherwise can be used external to the process.

The PCC technology employed for carbon capture can include a cryogenic process or an amine-based solution. PCC unit 21 can receive low or neutral carbon intensity energy from gas turbine 20 and/or carbon negative energy from biomass power plant 10 in three forms: (1) electrical power 103-ELEC and/or 203-ELEC that can be used to provide power to rotating equipment motors, including but not limited to the amine pumps (amine-based carbon capture), liquid carbon dioxide pumps (cryogenic carbon capture), auxiliary equipment, instrumentation, and controls; (2) thermal energy in the form of steam 103-STM and/or 203-ELEC for process heating requirements, including but not limited to the amine regenerator reboiler (amine-based carbon capture); and/or (3) steam drive energy to power the mechanical drive of rotating equipment.

Although not shown, PCC unit 21 can optionally be combined with PCC unit 43 in biomass power plant 10.

In an illustrative embodiment of the present invention, Table 1 demonstrates the required energy produced from a biomass power plant with carbon capture to achieve a hydrogen product having desired low carbon intensity for a 100 MTPD hydrogen electrolysis unit:

TABLE 1

| | | |
|---|---|---|
| Hydrogen Production | 4,167 kg/hr | 4,167 kg/hr |
| Electrolyzer Specific Energy | 55 kWh/kg H₂ | 55 kWh/kg H₂ |
| Total Required Power | 229.2 MW | 229.2 MW |
| Supplemental Power Source | Grid Import | Gas Turbine + PCC |
| Supplemental Power Fuel Source | — | GREET Standard Natural Gas |
| | | 13.74 kg CO₂e/MMBTU |
| Supplemental Power Carbon Intensity | 465 kg CO₂e/MWh | 82 kg CO₂e/MWh |
| Biomass Power Source | Biomass Energy + PCC | Biomass Energy + PCC |
| Biomass Power Carbon Intensity | −2,000 kg CO₂e/MWh | −2,000 kg CO₂e/MWh |
| Biomass Power Plant Size | 42.5 MW | 8.1 MW |
| Hydrogen Product Carbon Intensity | 0.45 kg CO₂e/kg H₂ | 0.45 kg CO₂e/kg H₂ |

As shown in Table 1, 100 MTPD of hydrogen produced from electrolysis having a target carbon intensity of 0.45 kg CO₂e/kg H₂ would require 42.5 MW of power provided by a biomass power plant with carbon capture and 186.7 MW of power provided by grid import electricity, in accordance with certain teachings of the present invention. Alternatively, 100 MTPD of hydrogen produced from electrolysis having a target carbon intensity of 0.45 kg CO₂e/kg H₂ would require 8.1 MW of power from a biomass power plant with carbon capture and 221.1 MW of power provided by a combine cycle gas turbine with carbon capture, in accordance with certain teachings of the present invention.

A target hydrogen carbon intensity of less than 0.45 kg CO₂e/kg H₂ can be achieved by properly balancing the size of the biomass power plant and the higher carbon intensity energy (i.e., local grid electricity and/or electricity produced from a gas turbine).

Table 2 illustrates the carbon intensity of electricity generated by various gas turbine configurations and fuel sources.

TABLE 2

| | Fuel Source and | Produced Electricity |
|---|---|---|
| Configuration | Life Cycle Carbon Intensity | Life Cycle Carbon Intensity |
| Combine Cycle Gas Turbine | Natural Gas (GREET Standard) | 394 kg CO2e/MWh |
| | 13.74 kg CO2e/MMBTU | |
| Combine Cycle Gas Turbine | Natural Gas (GREET Standard) | 82 kg CO2e/MWh |
| with Post Combustion Capture | 13.74 kg CO2e/MMBTU | |
| Combine Cycle Gas Turbine | 50%-v Natural Gas + 50%-v Hydrogen | 310 kg CO2e/MWh |
| | 13.74 kg CO2e/MMBTU (Natural Gas) | |
| | 0 kg CO2e/MMBTU (Hydrogen) | |
| Combine Cycle Gas Turbine | Hydrogen | 0 kg CO2e/MWh |
| | 0 kg CO2e/MMBTU | |

In yet another embodiment of the present invention, a method for producing a hydrogen product having a carbon intensity less than about 0.45 kg CO₂e/kg H₂ is provided. The method includes the steps of converting water to oxygen and the hydrogen product through an electrolysis process, providing at least some, and substantially all, of the required energy for the electrolysis process from a biomass power plant, and processing one or more flue gas streams from the biomass power plant in a carbon capture unit to reduce CO₂e emissions. The hydrogen product has a carbon intensity preferably less than about 0.45 kg CO₂e/kg H₂, and more preferably less than about 0.0 kg CO₂e/kg H₂. At least some of the required energy for the electrolysis process may be provided from a higher carbon intensity energy source. At least some of the required energy for the carbon capture unit from the biomass power plant. The energy produced from the biomass power plant may comprise one or more of electricity, steam used as process steam in the electrolysis process, steam used as thermal energy in the electrolysis process, and steam used to power a mechanical drive for one or more compressors, pumps, or other motors generating shaft torque in the electrolysis process. The energy produced from the biomass power plant may be generated by a Rankine cycle, a Brayton cycle, or by the gasification of biomass in an integrated gasification combined cycle. The biomass feedstock for the biomass power plant comprises one or more renewably sourced fuels selected from woody biomass, municipal solid waste, sorted municipal solid waste, food waste, agricultural waste, landfill diversion, hurricane and construction debris, industrial processing biomass waste, renewable natural gas, or a combination thereof, and may be co-fired with one or more fossil fuels. The electrolysis process is selected from polymer electrolyte membrane electrolysis, alkaline electrolysis, solid oxide electrolysis, or a combination thereof. The carbon capture unit comprises pressurizing the carbon dioxide product therefrom, wherein at least some of the required energy for the carbon dioxide pressurization is provided from the biomass power plant. The electrolysis process comprises compressing the hydrogen product, wherein at least some of the required energy for the hydrogen compressor is provided from the biomass power plant. The hydrogen production process comprises hydrogen liquefaction, wherein at least some of the required energy for the hydrogen liquefaction is provided from the biomass power plant. The biomass power plant comprises oxy-combustion of the biomass feedstock, wherein at least some of the required oxygen required for the oxy-combustion is provided by the electrolysis process.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and spirit of the present invention.

What is claimed is:

1. A method for producing a hydrogen product having a carbon intensity less than about 0.45 kg CO₂e/kg H₂, comprising:
converting water to oxygen and the hydrogen product through an electrolysis process;
providing at least some of the required energy for the electrolysis process from a biomass power plant; and
processing one or more flue gas streams from the biomass power plant in a carbon capture unit to reduce CO₂e emissions;
wherein the hydrogen product has a carbon intensity less than about 0.45 kg CO₂e/kg H₂.

2. The method of claim 1, wherein at least some of the required energy for the electrolysis process is provided from a higher carbon intensity energy source.

3. The method of claim 1, wherein at least some of the required energy for the carbon capture unit from the biomass power plant.

4. The method of claim 1, wherein substantially all of the required energy for the electrolysis process from the biomass power plant.

5. The method of claim 1, wherein the energy produced from the biomass power plant comprises electricity.

6. The method of claim 1, wherein the energy produced from the biomass power plant comprises steam used as process steam in the electrolysis process.

7. The method of claim 1, wherein the energy produced from the biomass power plant comprises steam used as thermal energy in the electrolysis process.

8. The method of claim 1, wherein the energy produced from the biomass power plant comprises steam used to power a mechanical drive for one or more compressors, pumps, or other motors generating shaft torque in the electrolysis process.

9. The method of claim 1, wherein the energy produced from the biomass power plant is generated by a Rankine cycle.

10. The method of claim 1, wherein the energy produced from the biomass power plant is generated by a Brayton cycle.

11. The method of claim 1 wherein the energy produced from the biomass power plant is generated by the gasification of biomass in an integrated gasification combined cycle.

12. The method of claim 1, wherein the biomass feedstock for the biomass power plant comprises one or more renewably sourced fuels selected from woody biomass, municipal solid waste, sorted municipal solid waste, food waste, agricultural waste, landfill diversion, hurricane and construction debris, industrial processing biomass waste, renewable natural gas, or a combination thereof.

13. The method of claim 12, wherein the biomass feedstock is co-fired with one or more fossil fuels.

14. The method of claim 1, wherein the electrolysis process is selected from polymer electrolyte membrane electrolysis, alkaline electrolysis, solid oxide electrolysis, or a combination thereof.

15. The method of claim 1, wherein the carbon capture unit comprises pressurizing the carbon dioxide product therefrom, wherein at least some of the required energy for the carbon dioxide pressurization is provided from the biomass power plant.

16. The method of claim 1, wherein the electrolysis process comprises compressing the hydrogen product, wherein at least some of the required energy for the hydrogen compressor is provided from the biomass power plant.

17. The method of claim 1, wherein the hydrogen production process comprises hydrogen liquefaction, wherein at least some of the required energy for the hydrogen liquefaction is provided from the biomass power plant.

18. The method of claim 1, wherein the biomass power plant comprises oxy-combustion of the biomass feedstock, wherein at least some of the required oxygen required for the oxy-combustion is provided by the electrolysis process.

19. The method of claim 1, wherein the hydrogen product has a carbon intensity less than about 0.0 kg CO₂e/kg H₂.
